(19) United States
(12) Patent Application Publication
(10) Pub. No.: US 2012/0124395 A1
(43) Pub. Date: May 17, 2012

(54) COMPUTER POWER SUPPLY

(75) Inventor: AN-GANG LIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/954,662

(22) Filed: Nov. 25, 2010

(30) Foreign Application Priority Data
Nov. 16, 2010 (CN) 201010546407.6

(51) Int. Cl. G06F 1/26

(52) U.S. Cl. 713/300

(57) ABSTRACT

A computer power supply includes a case and a number of power connectors. The power connectors are mounted on the case and operable to receive different kinds of power signals from the case. Each power connector outputs a corresponding power signal through a corresponding power adapter cable.

### BACKGROUND

1. Technical Field

The present disclosure relates to a computer power supply.

2. Description of Related Art

A computer power supply is a necessary element in a computer. A common computer power supply may include a substantially rectangular case, a power circuit arranged in the case, and a number of power cables connected at one end to the power circuit and with the other end exposed outside of the case. The exposed ends of the power cables are connected to a number of different power connectors, which are connected to components of the computer, such as motherboards, hard disk drives. However, some of the power cables may be not used but still occupy space in the computer, which may influence heat dissipation. Furthermore, when the computer is being tested, the length of the power cables may be not long enough to connect to an external test device, which is very inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, schematic view of an embodiment of a computer power supply, together with a power adapter cable.

FIG. 2 is an assembled view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

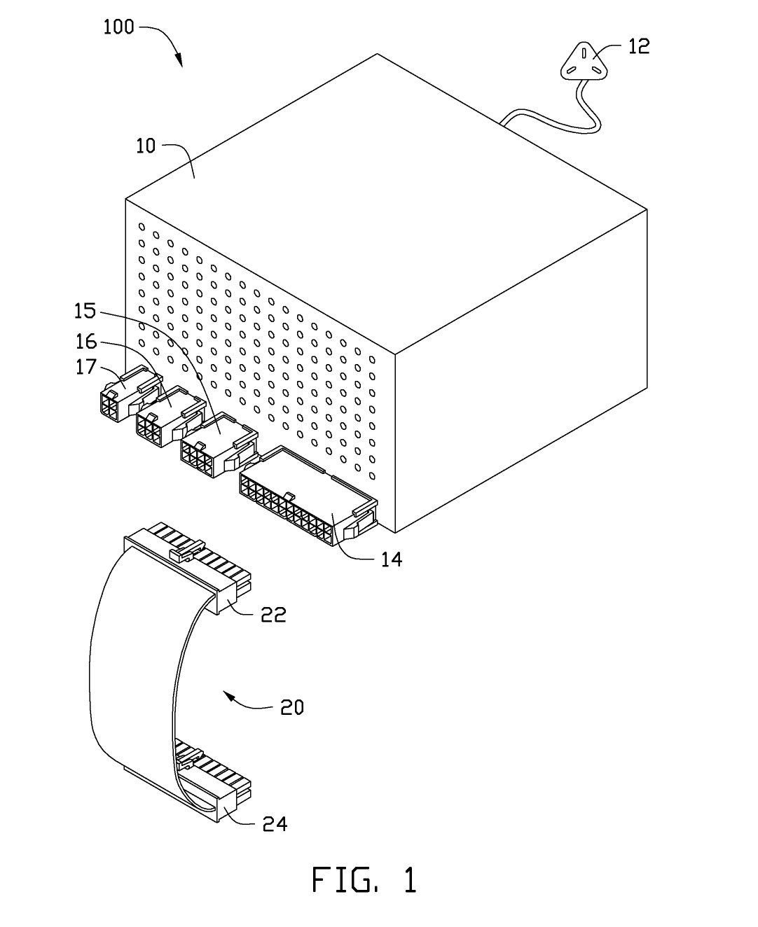

Referring to FIG. 1, an embodiment of a computer power supply 100 (hereinafter referred to as power supply 100), includes a substantially rectangular case 10. A power circuit (not shown) arranged in the case 10, a power plug 12 used to receive an external power supply, and a plurality of power connectors 14, 15, 16, and 17 directly mounted on the case 10. The power circuit falls within well-known technologies, and is therefore not described here.

In one embodiment, the power connectors 14, 15, 16, and 17 are different kinds of power connectors. In detail, the connector 14 is a twenty-four pin power connector, the connector 15 is an eight pin power connector, the connector 16 is a six pin power connector, and the connector 17 is a four pin power connector. In other embodiments, the number and types of the power connectors can be adjusted according to requirement. Each power connector is used to receive a power signal from the power circuit, such as 3.3 volts (V), 5V, and 12V power signals.

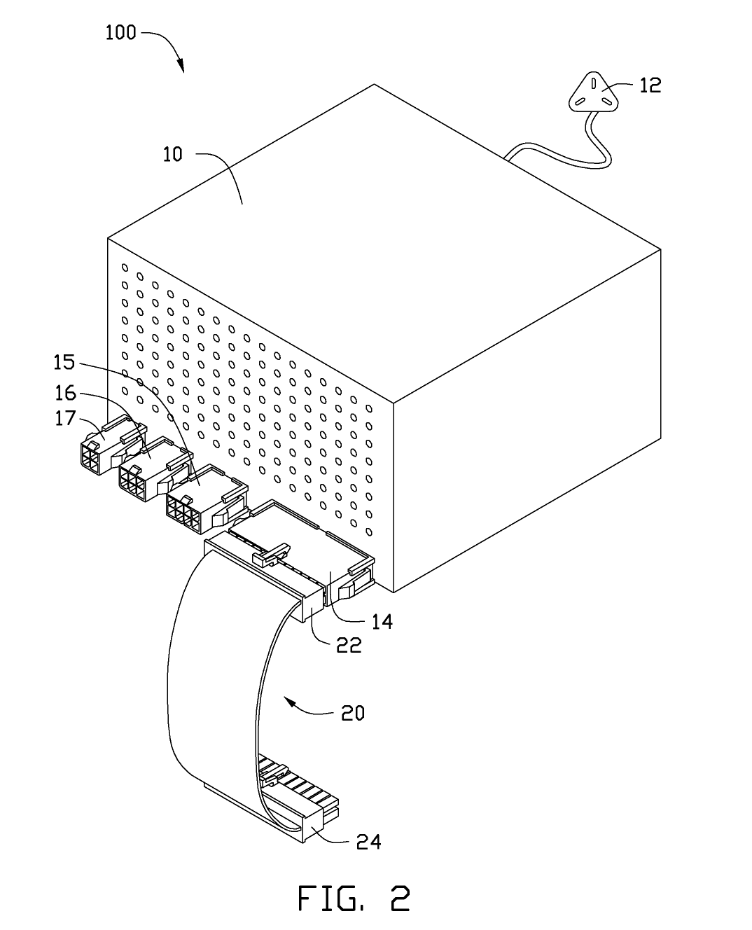

Referring to FIG. 2, when the power supply 100 is applied to a computer (not shown), the power plug 12 is connected to an external power supply, such as a 220V power supply. The power connectors 14, 15, 16, and 17 will receive corresponding power signals from the power circuit. Some required power connectors are connected to corresponding elements of the computer through corresponding power adapter cables, for example, a first power plug 22 of a power adapter cable 20 is connected to the power connector 14 and a second power plug 24 of the power adapter cable 20 is connected to a power interface of the motherboard of the computer, therefore the motherboard can receive power from the computer power supply 100 through the power adapter cable 20 and the power connector 14.

In actual use, when one or more power connectors of the power supply 100 are not needed, the corresponding power adapter cables of the unused power connectors do not need to be used, which can save cost and increase heat dissipating effect. Furthermore, if the computer is being tested and an external test device is positioned away from the computer, the user can select a proper power adapter cable to connect the external test device and the power supply 100, which is very convenient.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A computer power supply comprising:
a case; and
a plurality of power connectors directly mounted on the case, and operable to receive different kinds of power signals from the case;
wherein each of the plurality of power connectors outputs a corresponding power signal through a corresponding power adapter cable.

2. The computer power supply of claim 1, wherein the plurality of power connectors comprise a four pin power connector, a six pin power connector, an eight pin power connector, and a twenty-four pin power connector.

3. The computer power supply of claim 1, wherein the power signals comprise 3.3 volt (V), 5V, and 12V power signals.
